(19) United States
(12) Patent Application Publication
(10) Pub. No.: US 2004/0092148 A1
(43) Pub. Date: May 13, 2004

(54) Memory socket connector

(76) Inventor: Hung-Chi Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/313,240

(22) Filed: Dec. 5, 2002

(30) Foreign Application Priority Data
Nov. 13, 2002 (TW) 91218155

(51) Int. Cl. H01R 13/62

(52) U.S. Cl. 439/326

(57) ABSTRACT

An electrical connector (10) includes an upper connector portion (12) including a first insulating housing (16′) having a first elongated body (17) with a pair of side arms (25) extending forwardly from opposite ends of the first body and a lower connector portion (14) including a second elongated insulating housing (16) fixedly assembled to the first housing. The first and second housings respectively define first and second receiving slots (18′, 18) for receiving first and second modules (100) therein. A number of first and second contacts (50, 52; 40, 42) is respectively received in the first and second housings for electrically contacting with the first and second modules.

### BACKGROUND OF THE INVENTION

1. Field of the Invention

The present invention relates to an electrical connector, and particularly to a memory socket connector used in notebook computers.

2. Description of Related Art

U.S. Pat. No. 5,755,585 discloses a memory socket connector including a lower connector portion and an upper connector portion. The upper and lower connector portions are substantially identical in structure each comprising an insulating housing and a plurality of contacts retained in the housing. The insulating housing includes an elongated body defining a receiving slot for receiving a memory module therein and two rows of passageways by two sides of the receiving slot with the contacts received therein for electrically contacting with the inserted memory module. A pair of latch arms extends forwardly from opposite ends of the elongated body for retaining the memory module in the housing.

U.S. Pat. No. 6,319,035 discloses a memory socket connector of another type including a unitary insulating housing having an upper connection port and a lower connection port for respectively receiving upper and lower memory modules therein. The upper connection port is somewhat forwardly offset from the lower connection port in a front-to-back direction of the memory socket connector. Each connection port defines a receiving slot and two rows of passageways by two sides of the slot with the contacts received therein for electrically contacting with a corresponding inserted memory module. A pair of latch arms is respectively integrally formed at two opposite ends of the upper and lower connection ports for retaining the memory modules in the memory socket connector.

However, because the insulating housing of each above-mentioned connector has latch arms formed at opposite sides thereof, the insulating housing is easy to deform during the injection molding thereof, thereby adversely affecting the coplanarity of the memory socket connector. Accordingly, an electrical connection is adversely affected between the memory socket connector and a printed circuit board on which the connector is seated.

Hence, an improved memory socket connector is required to overcome the disadvantages of the related art.

### SUMMARY OF THE INVENTION

Accordingly, it is an object of the present invention to provide a memory socket connector having better coplanarity to thereby ensuring a better connection between the memory socket connector and a printed circuit board on which the connector is seated.

In order to achieve the object set forth, a memory socket connector in accordance with the present invention comprises an upper connector portion including a first insulating housing and a lower connector portion including a second elongated insulating housing fixedly assembled to the first housing. The first housing has a first elongated body defining a first receiving slot for receiving a first memory module therein and a pair of side arms extending forwardly from opposite ends of the first body. The second elongated housing defines a second receiving slot for receiving a second memory module therein. A plurality of first and second contacts is respectively received in the first and second housings for electrically contacting with the first and second memory modules.

Other objects, advantages and novel features of the invention will become more apparent from the following detailed description when taken in conjunction with the accompanying drawings.

### BRIEF DESCRIPTION OF THE DRAWINGS

FIG. 1 is an exploded, perspective view of a memory socket connector in accordance with the present invention;

FIG. 2 is an assembled view of the memory socket connector with an auxiliary separate metal member adapted to be attached thereto and a pair of memory modules to be inserted into the connector;

FIG. 3 is a cross-sectional view of a lower connector portion of FIG. 2 with corresponding contacts therein;

FIG. 4 is a cross-sectional view of the upper connector portion of FIG. 2 with corresponding contacts therein; and

FIG. 5 is a perspective view showing the memory socket connector mounted on a printed circuit board with the memory modules being inserted thereinto.

### DETAILED DESCRIPTION OF THE INVENTION

Reference will now be made in detail to the preferred embodiment of the present invention.

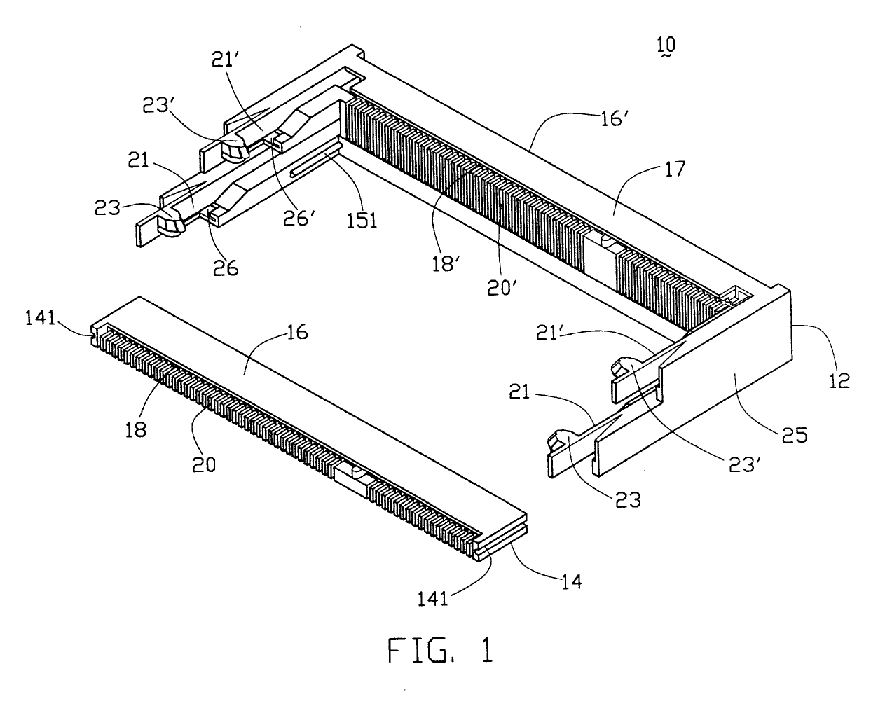

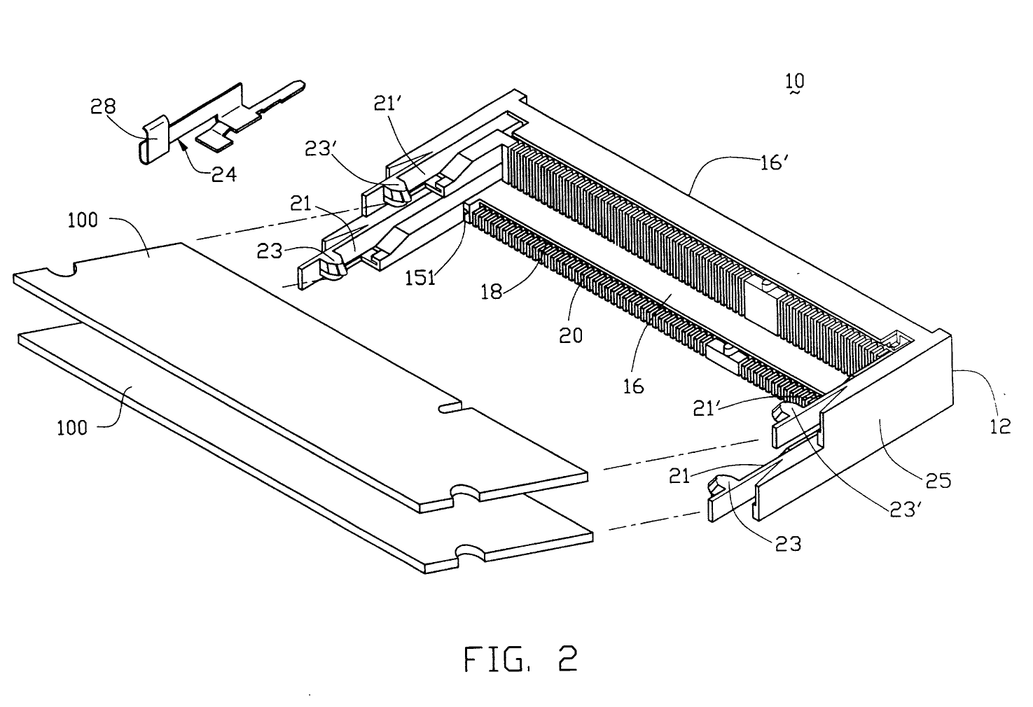

Referring to FIGS. 1 and 2, a memory socket connector 10 in accordance with the present invention comprises an upper connector portion 12 and a lower connector portion 14 for respectively receiving upper and lower memory modules 100 therein. In the preferred embodiment of the present invention, the upper and lower connector portions 12, 14 are SO DIMM (Small Outline Dual Inline Memory Module) connectors.

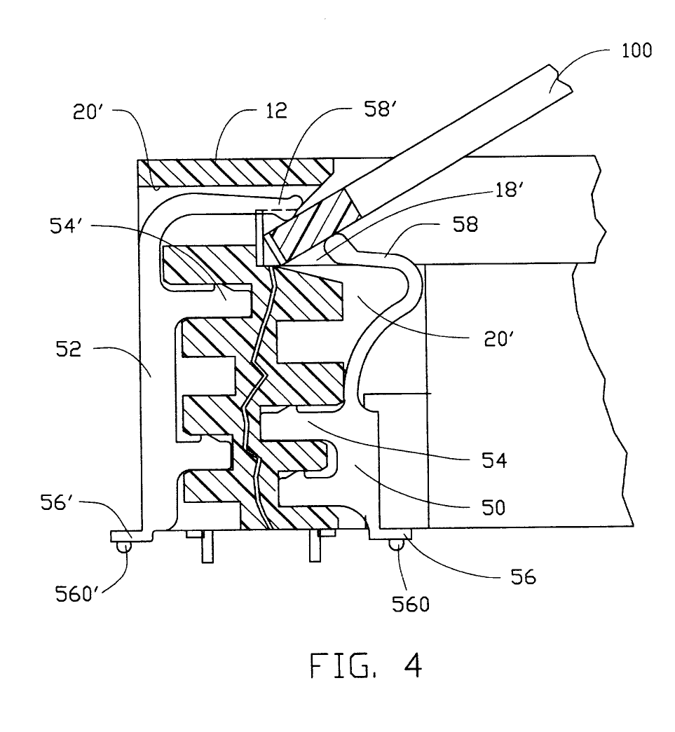

Referring to FIG. 4 in conjunction with FIGS. 1 and 2, the upper connector portion 12 comprises a first insulating housing 16′ and a plurality of first contacts 52, 50 received in the first housing 16′ in upper and lower rows. The first housing 16′ includes a first elongated body 17 defining a first receiving slot 18′ therein for receiving the upper module 100 and two rows of first passageways 20′ in front and rear surfaces thereof communicating with the first receiving slot 18′ for receiving the first contacts 50, 52. A pair of side arms 25 extends forwardly from opposite ends of the first elongated body 17. Each side arm 25 includes an upper latch section 21′ and a lower latch section 21 wherein the upper latch section 21′ has a smaller length than that of the lower latch section 21. The upper and lower latch sections 21′, 21 respectively have an enlarged locking head 23′, 23 formed adjacent a distal end thereof for retaining the memory module 100. The side arms 25 define a pair of projections 151 on inner surfaces thereof.

A auxiliary metal member 24 is employed to be optionally inserted into a cavity 26′ in the upper latch section 21′. The metal member 24 includes a grasping section 28 which can cooperate with the upper latch section 21′ for outward deflection of the upper latch section 21′ to thereby releasing the memory module 100 from the first housing 16′. The lower latch section 21 has the same metal member 24 received in a cavity 26 thereof.

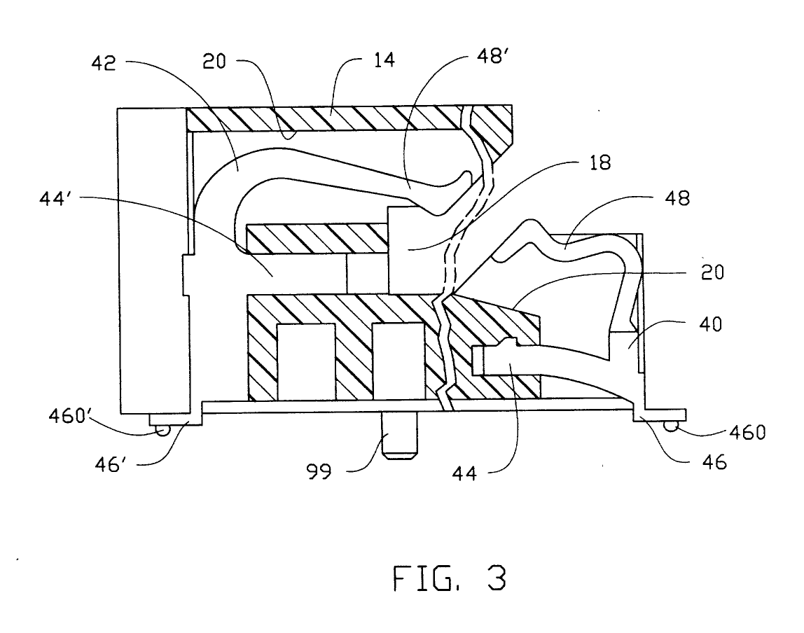

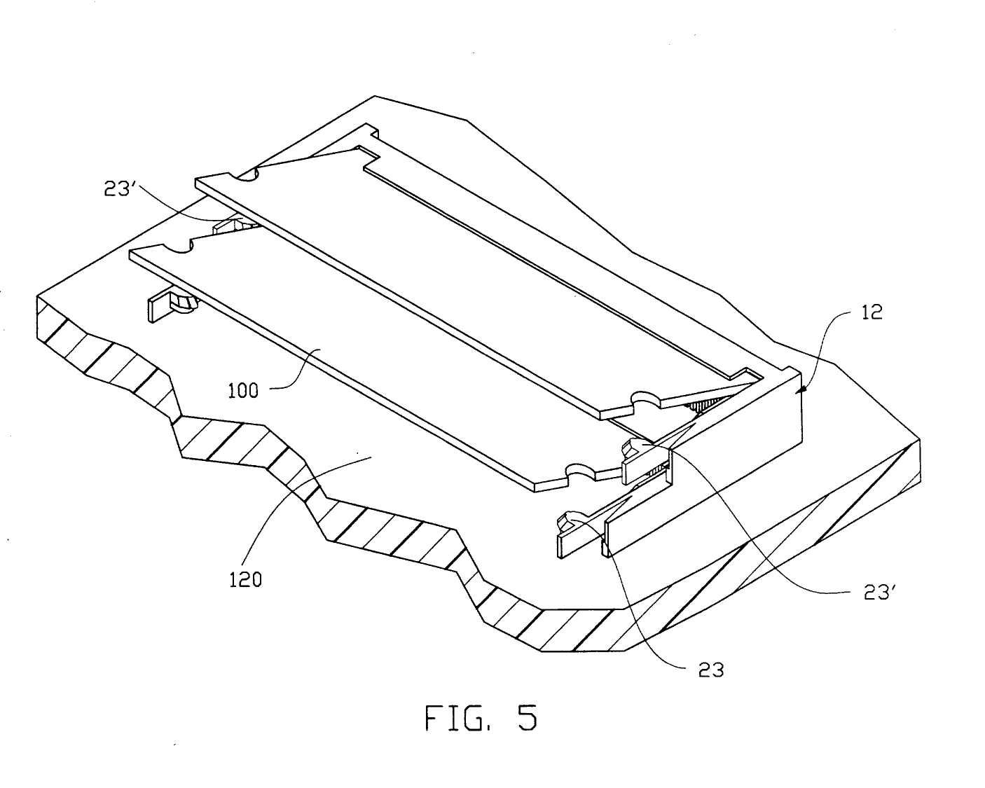

Referring to FIG. 3 in conjunction with FIGS. 1 and 2, the lower connector portion 14 includes a second elongated insulating housing 16 and a plurality of second contacts 42, 40 received in the second housing 16 in upper and lower rows. The second housing 16 defines a second receiving slot 18 in a longitudinal direction thereof for receiving the lower module 100 and two rows of second passageways 20 in front and rear surfaces thereof communicating with the receiving slot 18 for receiving the second contacts 40, 42. The second housing 16 defines a pair of recesses 141 in opposite side surfaces thereof for receiving the projections 151 of the first housing 16′. In addition, a positioning post 99 integrally extends downward from a bottom of the second housing 16 for being received within a corresponding through hole of a printed circuit board 120 (FIG. 5) on which the memory socket 10 is seated.

Referring to FIG. 3 again, the second contacts 42, 40 are respectively received within the upper row and lower row passageways 20 wherein the second lower row contacts 40 are inserted into the corresponding passageways 20 from the front side and the second upper row contacts 42 are inserted into the corresponding passageways 20 from the back. The lower row contacts 40 each includes a retention section 44 interferentially fitted within the corresponding passageway 20 for retaining the contact 40 within the second housing 16, a mounting section 46 with a solder ball 460 fused on a bottom thereof for soldering to the printed circuit board 120 and an engagement section 48 projecting into the receiving slot 18 for engagement with a corresponding circuit pad of the lower memory module 100. Similarly, the upper row contacts 42 each includes a retention section 44′, a mounting section 46′ with a solder ball 460′ fused on a bottom thereof and an engagement section 48′. Differently, the upper row contacts 42 are inserted into the corresponding passageways 20 from the back.

Similar to the second contacts 40, 42 of the lower connector portion 14, referring to FIG. 4 again, the first contacts 50, 52 of the upper connector portion 12 include retention sections 54, 54′, mounting sections 56, 56′ respectively with solder balls 560, 560′ fused thereon and engagement sections 58, 58′ wherein the first lower contacts 50 thereof are inserted into the corresponding first passageways 20′ from the front side and the first upper contacts 52 thereof are inserted into the corresponding first passageways 20′ from the back. Differently, the height of the first contacts 50, 52 are larger than that of the second contacts 40, 42.

Referring to FIG. 5, in assembly, the first and second contacts 50, 52, 40, 42 are first respectively inserted into the first and second housings 16′, 16 to form the upper and lower connector portions 12, 14. The lower connector portion 14 is then assembled to the upper connector portion 12 in a horizontal direction wherein the projections 151 of the first housing 16′ are interferentially fitted within the recesses 141 of the second housing 16, whereby the lower connector portion 14 and the upper connector portion 12 are fixedly assembled together. It is noted that the projections 151 of the first housing 16′ also function as guiding portion for facilitating assemblage of the lower connector portion 14. It is also noted that the lower connector portion 14 can be fixed to the upper connector portion 12 through other conventional coupling means. At the same time, the upper connector portion 12 and the lower connector portion 14 are substantially offset with each other in a front-to-back direction, whereby the lower module 100, which is ready to be inserted into the lower connector portion 14, is able to approach the lower connector portion 14 at an angle with its upper surface substantially positioned below the enlarged locking head 23′ of the upper latch section 21′ for avoiding improper interference between the lower module 100 and the enlarged locking head 23′ of the upper latch section 21′ for reaching its final horizontal fixed position.

It can be understood that a feature of the present invention is that the coplanarity of the second insulating housing 16 of the memory socket 10 can be better ensured during the injection molding thereof since the second insulating housing 16 is substantially in a linear fashion, whereby a better connection is ensured between the memory socket connector 10 and the printed circuit board 120. At the same time, the mechanical strength of the memory socket connector 10 is still ensured since the first insulating housing 16′ have a pair of side arms 25 formed at opposite ends of the first elongated body 17 thereof.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector for use with two modules, comprising:
an upper connector portion, comprising:
a first insulating housing having a first elongated body defining a first receiving slot for receiving a first module therein;
a plurality of first contacts received in the first elongated body for electrically contacting with the first module; and
a pair of side arms extending forwardly from opposite ends of the first elongated body; and
a lower connector portion fixedly assembled to the upper connector portion, comprising:
a second elongated insulating housing attached to the first housing and defining a second receiving slot for receiving a second module therein; and
a plurality of second contacts received in the second housing for electrically contacting with the second module.

2. The electrical connector as claimed in claim 1, wherein the side arms of the first housing define a pair of projections on inner surfaces thereof, and the second housing defines a pair of recesses receiving the projections therein.

3. The electrical connector as claimed in claim 1, wherein each side arm of the first housing includes first and second latch sections respectively for retaining the first and second modules.

4. The electrical connector as claimed in claim 3, wherein the first and second latch sections of each side arm respectively have an enlarged locking head for respectively positioning the first and second modules.

5. The electrical connector as claimed in claim 1, wherein the upper and lower connector portions are SO DIMM (Small Outline Dual Inline Memory Module) connectors.

6. The electrical connector as claimed in claim 5, wherein the contact of each connector portion has a mounting portion with a solder ball fused thereon for soldering to a printed circuit board.

7. A stacked connector assembly for use with two modules, comprising:
an upper connector portion and a lower connector portion,
said upper connector portion including:
a first insulating housing defining a first elongated body with a first receiving slot therein;
a plurality of first contacts disposed in the first elongated body and extending into the first receiving slot;
a first pair of side latches integrally extending forwardly from two opposite ends of the first elongated body and substantially located at a same level with the first receiving slot;
a second pair of side latches integrally extending forwardly from said two opposite ends of the first elongated body and under said first pair of side latches;
said lower connector portion including:
a second insulating housing attached to the first housing, said second insulating housing defining a second elongated body with a second receiving slot therein; and
a plurality of second contacts disposed in said second body and extending into the second receiving slot; wherein
said second pair of side latches are at a same level with the second receiving slot.

8. The assembly as claimed in claim 7, wherein said second body is substantially forwardly offset from the first body.
